(19) United States
(12) Patent Application Publication
(10) Pub. No.: US 2010/0124651 A1
(43) Pub. Date: May 20, 2010

(54) METHOD OF MANUFACTURING NANO-CRYSTALLINE CELLULOSE FILM

(75) Inventors: Stéphane ROUSSEAU, Laval (CA); Balázs TOLNAI, Montreal (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(73) Assignee: KRUGER INC., Montreal (CA)

(21) Appl. No.: 12/614,519

(22) Filed: Nov. 9, 2009

Related U.S. Application Data
(60) Provisional application No. 61/193,316, filed on Nov. 17, 2008.

(51) Int. Cl. B32B 3/26; B05D 3/02

(52) U.S. Cl. 428/304.4; 427/384; 977/890

(57) ABSTRACT

The present invention provides a method of manufacturing a film containing nano-crystalline cellulose.

### FIELD OF THE INVENTION

The invention relates to nano-crystalline cellulose film and in particular to a method of manufacturing a film containing nano-crystalline cellulose.

### BACKGROUND OF THE INVENTION

Cellulose is a semi-crystalline high-molecular weight homopolymer contained in virtually all plants. Its semi-crystalline nature implies it has ordered crystalline regions as well as disordered amorphous regions. Subjecting cellulose to degradation via acid hydrolysis yields a suspension of cellulose crystals because the amorphous regions are preferentially hydrolized. Depending on the hydrolysis conditions, cellulose can be degraded into crystals that are between the micron and nanometer ranges—typically, nanocrystals would result from further hydrolyzing, and subjecting microcrystals to high shear forces. Nanocrystalling cellulose has a size distribution that is species-dependent, but the typical range of crystal edge dimensions is 1-100 nm and that of crystal lengths is 20-2000 nm. Even though the tensile properties of nano-crystalline cellulose are an order of magnitude below those of carbon nanotubes, which is currently the strongest known structural material, they are sufficiently high to justify its inclusion into engineered biocomposite materials. Currently, both pure nano-crystalline cellulose films and nano-crystalline cellulose-based composite films have only been produced on a laboratory scale, and have not been commercially isolated. The challenges and uncertainties associated with the commercial production of both pure and composite nano-crystalline cellulose films are numerous, and include: the films' lack of flexibility, their low release coefficients, their behaviour under tension, their drainage characteristics and their response to impingement drying.

### SUMMARY OF THE INVENTION

In one embodiment the present invention provides a method of manufacturing nano-crystalline cellulose film comprising the steps of (i) providing a suspension comprising nano-crystalline cellulose; (ii) uniformly dispensing the suspension onto at least one non-permeable sheet; (iii) drying the suspension using at least one non-contact drying apparatus; (iv) placing a semi-permeable sheet on the opposing surface of the suspension to the non-permeable sheet providing a sandwiched film configuration; (v) further drying the sandwiched film using at least one drying apparatus; (vi) removing the non-permeable sheet and the semi-permeable sheet from the sandwiched film; (vii) optionally further drying the gelled nano-crystalline film.

In one embodiment the suspension used in the method of the present invention comprises less than about 10% solids. In another embodiment the suspension comprises less than about 7% solids. In an alternate embodiment the suspension comprises about 5% solids.

In one embodiment the suspension consists essentially of nano-crystalline cellulose. In an alternative embodiment the suspension comprises at least one additional material operable to form a sheet, the material may be, for example, wood pulp. In a further embodiment, the suspension further comprises at least one additive, for example, a filler and/or a pigment.

The present invention further provides a nano-crystalline cellulose film made by the method described herein.

### BRIEF DESCRIPTION OF THE DRAWINGS

The present invention will now be described in further detail with reference to the following figures:

FIGS. 1-8 show a schematic of one embodiment of the method of the present invention.

### DETAILED DESCRIPTION OF THE PREFERRED EMBODIMENTS

The present invention provides a method of manufacturing nano-crystalline cellulose film using a continuous process. The continuous process includes, but is not limited to, forming, pressing, drying, calendering and finishing the film, whose final state may be in roll or sheet form.

The method includes the use of a nano-crystalline cellulose suspension that may be prepared using techniques known in the art, including transformative technologies that use cellulosic fibre material from wood or vegetal sources, as described in [1] Wang, Neng; Ding, Enyong; Cheng, Rongshi: Preparation and liquid crystalline properties of spherical cellulose nanocrystals, Langmuir, Vol. 24, Nr. 1, pp: 5-8, (2008); [2] Habibi, Youssef; Foulon, Laurence; Aguioe-Boeghin, Voeronique; Molinari, Michaoel; Douillard, Roger: Langmuir-Blodgett films of cellulose nanocrystals: preparation and characterization, J. Colloid Interface Sci., Vol. 316, Nr. 2, pp: 388-397, (2007); [3] Bondeson, Daniel; Mathew, Aji; Oksman, Kristiina: Optimization of the isolation of nanocrystals from microcrystalline cellulose by acid hydrolysis, Cellulose, Vol. 13, Nr. 2, pp: 171-180, (2006).

The nano-crystalline cellulose suspension used in the method described herein contains a % of solids that allows the nano-crystalline cellulose to remain in suspension to be used in the process described herein. However, it will be understood that the initial suspension used may contain solids in the range of 7-10%. In this embodiment, the process may further include a high-shear headbox that is operable to disperse the nano-crystalline cellulose suspension onto the fabric, as described further below. The use of the high-shear headbox allows for uniform dispersion of the nano-crystalline cellulose suspension which may be in the form of a gel due to the high % of solids. The initial suspension used in the present invention preferably contains less than 10% solids, more preferably the suspension contains less than 7% solids. In a preferred embodiment, the suspension includes 5% solids.

The method of the present invention will be described in further detail with reference to the accompany Figures.

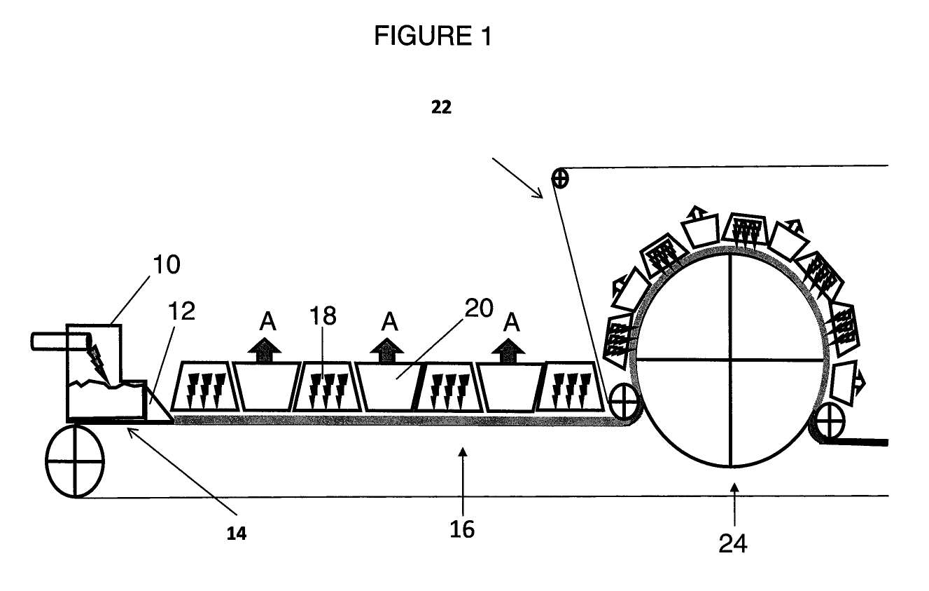

Initially, the nano-crystalline cellulose suspension is placed in a stabilisation unit or reservoir, identified at numeral 10 in FIG. 1. The reservoir is operable to dispense the suspension in an amount that provides uniform deposition of the suspension 12 onto a non permeable fabric 14. The non permeable fabric is suspended, and tensioned, between at least two rollers, at a position that allows the fabric to receive the suspension on its surface. It will be understood that the physical requirements of the non-permeable fabric will be chosen based on the nano-crystalline cellulose material being used. The fabric is chosen to ensure that any voids located within the fabric are not larger in size than the crystals in the nano-crystalline cellulose suspension.

In addition the non-permeable fabric is formed from a material that prevents water from permeating through it but allows water vapour to permeate through to assist in the drying process.

In order to achieve uniform deposition, of the suspension onto the fabric, the reservoir controls the amount and speed of the suspension leaving the reservoir. In addition, the non permeable fabric, onto which the suspension is placed, moves at a speed that may be adapted to allow for control of the amount of suspension received on the fabric.

In an alternative embodiment, the initial suspension comprises a mixture of nano-crystalline cellulose with other material, for example, traditional wood pulp, or additives. The mixture can then be used in the process described herein to form a composite material that includes nano-cellulose crystals. Examples of other materials that may be used include, but are not limited to, traditional wood pulp produced using any type of pulping process, for example, groundwood, thermo-mechanical pulping and haft pulping.

In an alternative embodiment, the initial suspension comprises a mixture of nano-crystalline cellulose with a plasticizing agent.

Other mixtures that may be used include a nano-crystalline cellulose suspension as described above in combination with additives, such as pigments and/or fillers. Examples of such additives include, but are not limited to clay, calcium carbonate and plastics.

It will be understood by a person skilled in the art that the pH, temperature and viscosity of the initial suspension, whether pure nano-crystalline cellulose or a mixture as described above, will affect the film-forming characteristics of the initial suspension.

As stated above, the fabric onto which the suspension is placed is a non permeable fabric. The non permeable fabric is formed of material that does not allow for the passage of fluids therethrough but allows for the passage of water vapour.

After the nano-crystalline suspension has been placed on the non permeable fabric the initial drying process begins, indicated in FIG. 1 at 16. Depending on the release coefficient of the film, which will vary with the species used to produce the nanocrsytals as well as with the additives, if any, present in the original suspension, one may find that direct contact drying apparatus, which is traditionally used in the paper making industry, may damage the film formation. Therefore, non contact drying apparatus, indicated generally at 18, is/are preferred to initiate the drying process for the film. Moisture is removed from the film through evaporation, indicated at arrows A, using a non direct heating source. Examples of the types of drying apparatus that may be used include, but are not limited to, IR dryers, microwave dryers, steam dryers, air impingement dryers. The apparatus may also include water vapour evacuation units, indicated generally at numeral 20.

Once the film and fabric has passed through the initial drying stage, an additional fabric layer is placed on top of the nano-crystalline cellulose layer. The additional fabric layer is preferably a semi permeable fabric layer, indicated at numeral 22, and is placed on the opposite surface of the nano-crystalline layer to the non permeable fabric. The addition of the semi permeable fabric creates a sandwich effect with the nano-crystalline film being surrounded by fabric. The semi permeable fabric layer is operable to allow for the passage of fluids and or gases through the fabric.

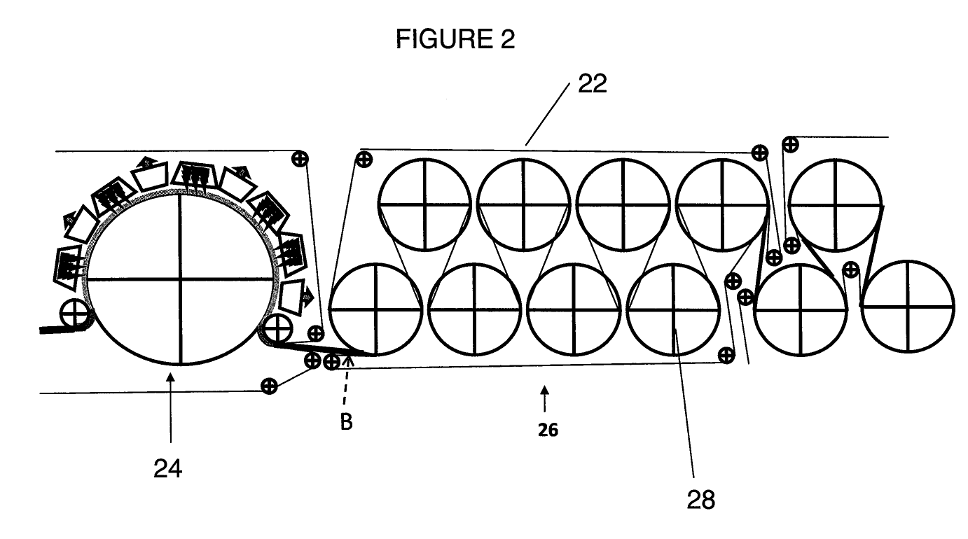

Once the nano-crystalline layer is placed between the two fabric layers the sandwiched film is then moved to a second drying stage, indicated at 24 in FIGS. 1 and 2. In this drying stage the sandwiched film is rolled onto at least one large drying unit. Preferably the drying unit is a cylindrical metallic dryer. Such dryers are known and used in the paper making industry and can include hot gas or steam dryers. The sandwiched film is pressed against the dryer with the non permeable fabric located adjacent the surface of the dryer. The fabric tension in the dryer section may be adapted by the user, however, an example of the fabric tension that may be applied is in the range of 1-2 KN/m.

Heat from the dryer is radiated through the non permeable fabric to the nano-crystalline film. The heat is transferred to the film and moisture in the film will then evaporate out of the film. The semi permeable fabric is therefore located on the outside which allows for moisture to evaporate from the nano-crystalline film and through and out of the semi permeable fabric.

It will be understood that the non permeable and semi permeable fabrics are used to maintain the nano-crystalline film within a support structure. Initially, the nano-crystalline film will not have gelled sufficiently to be able to be a self supporting film. Therefore, the sandwich configuration provides support for the structure of the film while allowing for sufficient heat to reach the film and moisture to evaporate. The fabric layers therefore provide support to the film structure while simultaneously allowing the film to dry and form a self-supporting film.

In this second stage of drying the sandwiched film may pass over one or between more than one drying unit. The number of units and the speed at which the sandwiched film passes between the units may be varied depending on the amount of drying required. Likewise, the amount of heat radiated from the dryers will also affect the rate of drying of the film.

Once the sandwiched film has passed through this second stage of drying, the nano-crystalline film will have gelled, shown at arrow B, and its consistency will permit transfer of the film to a separate drying stage, indicated at 26.

It will be understood that a person skilled in the art will be able to identify when the film has reached the gelling phase. The ability of the film to gel and form a more self sustaining film will be affected by the % solids included in the nano-crystalline cellulose suspension, the tensile strength and the tensile modulus of the film. These factors can be modified, for example, by reducing or increasing the % solids in the initial suspension, to ensure that the suspension is able to form a self-supporting gelled film at this stage of the process. In addition, modifications to the drying stages, e.g. length of drying time, heat emitted from the dryers and/or speed of the film passing through the drying stations, may be made to assist in the gelling of the film.

The third drying stage is often referred to in traditional paper making processes as a Unirun configuration, identified at numeral 26. It includes the use of a single semi permeable fabric sheet 22, on top of the nano-crystalline film. The nano-crystalline film is placed directly onto the drying apparatus and heat from the drying apparatus is transferred directly to the nano-crystalline film. Moisture evaporates from the nano-crystalline film out through the semi-permeable fabric. The semi-permeable fabric is used to hold the film against the drying apparatus while still allowing water vapour to evaporate from the film and through the fabric. This drying stage may include several drying apparatus 28, for example from about 3 up to about 20 dryer cans. The number of drying apparatus, or cans, will vary depending on the film stability, film machine speed and steam pressure in dryers. The number of individual drying apparatus used, the speed at which the film passes between them and the heat emitted by each drying apparatus may be changed or modified based on the drying requirements for the film.

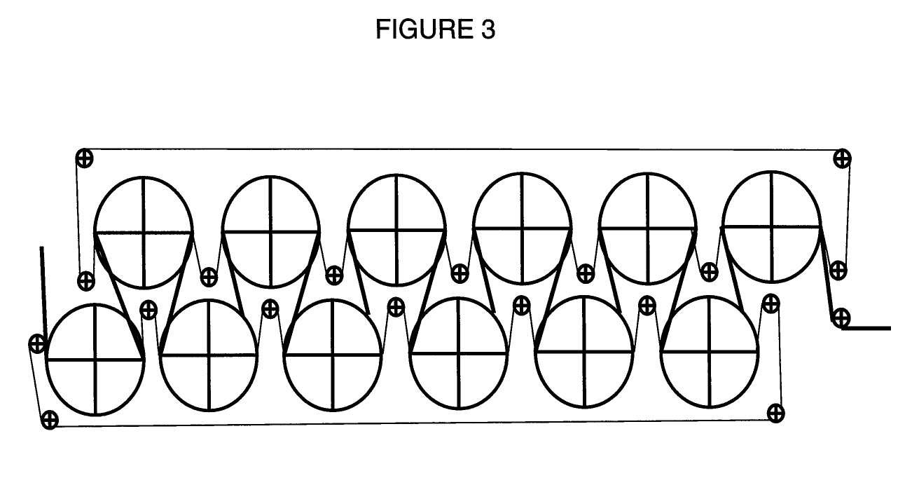

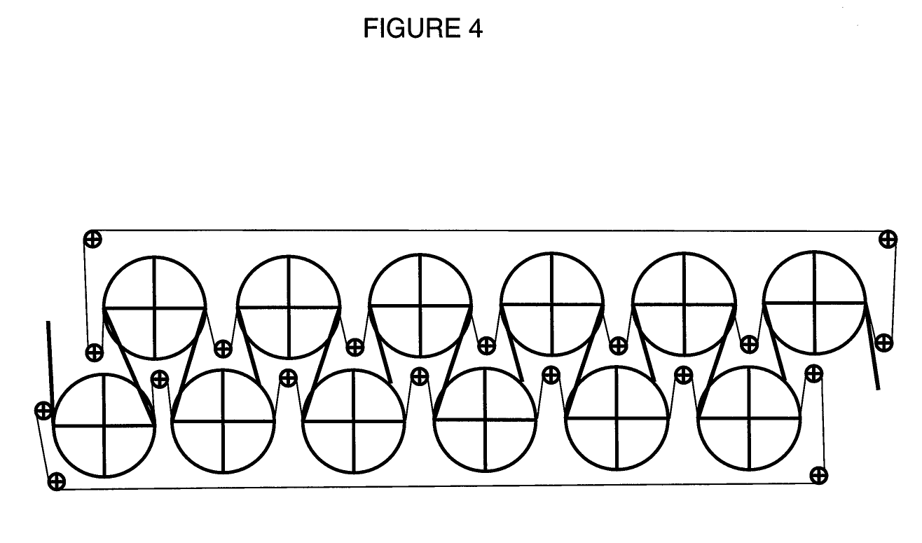

At the exit of the third stage of drying, the gelled film will be self-supporting. If necessary, fourth and fifth drying stages may be used to further increase the film solids content. These fourth and fifth drying stages, illustrated in FIGS. 3 and 4, would traditionally be double felted sections in which two semi permeable fabrics are used to pressure the film against the lower and upper drying cylinders of each section. Due to the self-supporting nature of the gelled film at this stage, the double felted sections, which have the advantage of higher evaporation rates, but which do not support the film at the transfer points located between each successive lower and upper drying cylinder, are preferably used instead of duplicate Unirun sections.

Temperature profiles, of the drying apparatus, are controlled to allow moisture removal without destroying film integrity. The number of dryer sections and dryers per section may vary based on steam pressure profiles, and the film requirements, i.e. film thickness and basis weight and also on the speed of the equipment.

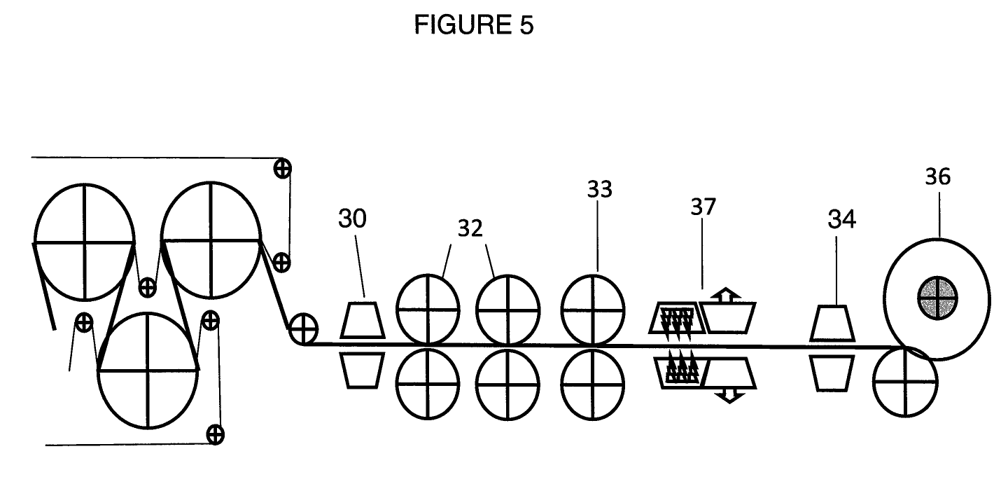

Once the film has passed through this drying stage it passes through a gauging system 30 shown in FIG. 5. The gauging system measures the properties of the film, including, but not limited to, moisture, basis weight, color, tensile strength, opacity, ash content and other critical physical characteristics. The gauging system can be used as a feedback control tool. Once the properties of the film have been measured if there are any that are noted as being outside of the predetermined parameters for the film then the method, and the apparatus used in the method thus far, can be adapted/manipulated to further control the process and the resulting film and its properties. For example, if the film is detected as having higher levels of moisture compared to what is ideally required at this stage, the speed of the film can be reduced to allow for longer drying cycles, or the steam pressure in any steam drying apparatus can be increased, or the tension in the sandwiched film can be increased, or combinations of these changes may be implemented.

After the film has passed through the gauging station, hard and/or soft calendering, indicated generally at 32 in FIG. 5, may be applied to the film. Calendering is used to improve the smoothness of the film surface and to further consolidate its structure. Depending on the required end use of the film, or depending on how the film has formed during the process, a combination of hard and/or soft calendering may be used. Hard calendering may be used if the aim is to optimise the surface properties of the film. Soft calendering may be used when an increase in the surface smoothness is required but maintaining the strength properties of the film is still important. Such processes are known and used in the art.

After the calendering station the film may optionally pass through a coating station, shown at numeral 33 in FIG. 5. If a coating station is included then a subsequent drying station, to dry the applied coat, may also be used, such as infra-red or steam dryer cans, shown in numeral 37. Coatings that may be used include substance that provide additional properties to the film for its end use. Examples of coating methods that may be used include, but are not limited to, jet coating, blade coating, curtain coating, spray coating and film coating. If a coat is chosen to address certain optical characteristics of the film, the coating formulation may include, but is not limited to, pigments such as titanium dioxide, calcium carbonate and kaolin clay.

Once the film has passed through the calendering and/or coating station, the film properties are measured again by a second gauging system 34 to provide feedback controls for the calendering and/or coating units.

It will be understood that the method of the present invention does not require all of the steps identified above. For example, the number of drying stages will depend on the efficiency of the initial drying stages. In addition the further processing steps that are discussed above to be applied to the film after formation are not required. For example, the gauging station, calendering and coating stations are optional.

At the end of the machine the film is put in reels, indicated generally at 36 in FIG. 5. The reels are built as wide as the machine and typically equivalent to 2 or 3 finished rolls in diameters. These reels are often referred to as the “parent” reel.

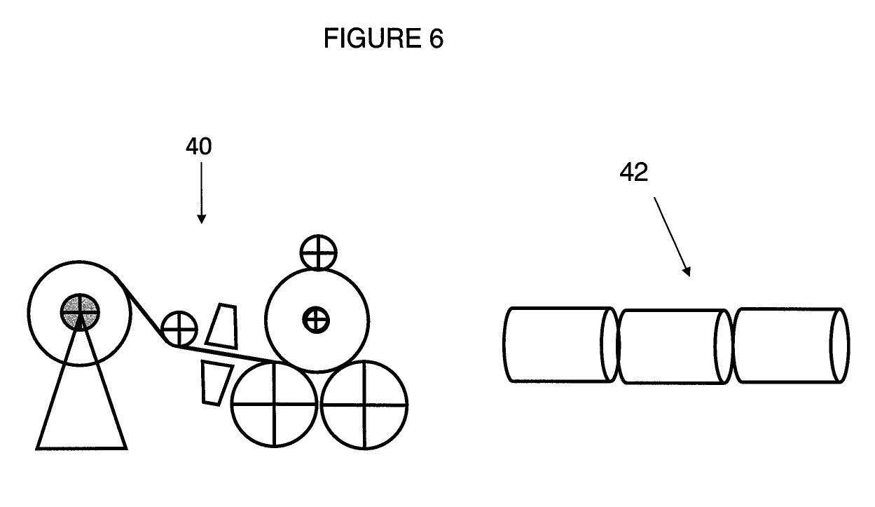

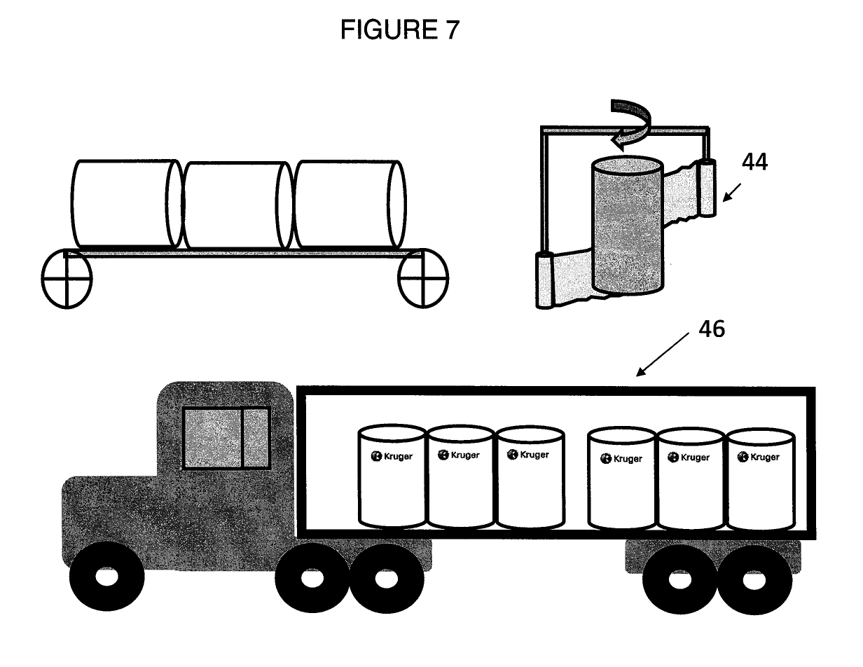

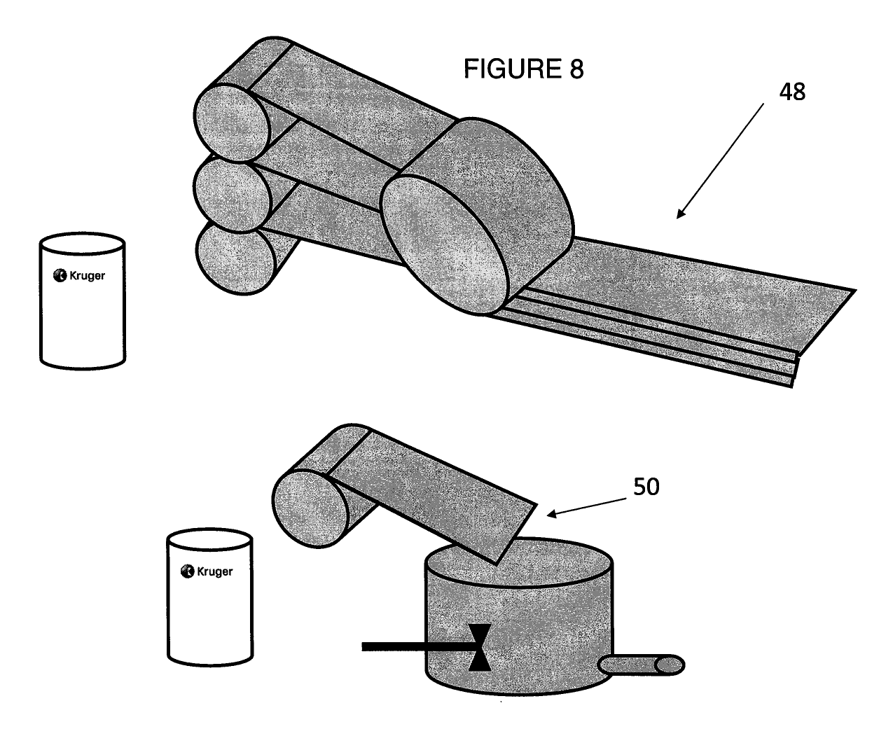

The “parent” reel is then moved to the winder, indicated by numeral 40 on FIG. 6, where it is slit into small rolls according to customer specifications, indicated in the Figures at 42. Rolls are then wrapped, indicated at numeral 44, and shipped, indicated at numeral 46, to customers as dry NCC film rolls. Alternatively, the parent reel may be fed to a sheeter which would output stacks of film sheets, according to the requirements of the end user, shown at numeral 48 in FIG. 8.

At the end users, i.e. the customers, the rolls of films may be processed further. Rolls can be unwound and processed for molding, film coating, laminating, forming, slit in sheets etc. Rolls can also be put in a pulper in order to prepare NCC suspension for specific applications, shown at numeral 50 in FIG. 8.

It will be understood by a person skilled in the art that not all of the process steps required above may be necessary for the nano-crystalline cellulose film or composite manufacturer. Some of the steps, for example the drying steps, may be removed if not required.

Examples of some of the end uses for nano-crystalline film include, but are not limited to (i) Aeronautics/Transportation for providing lighter components, better physical characteristics and longer life; (ii) Health & Science providing digestible/non-toxic film for digestive system; compatible film for chemical encapsulation; (iii) Electronics including film having polarisation characteristics; film that is more affordable than Carbon based products; (iv) Paper & Wood products including super resistant wood flooring varnishes; lightweight paper etc.

While this invention has been described with reference to illustrative embodiments and examples, the description is not intended to be construed in a limiting sense. Thus, various modification of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

Any publications, patents and patent applications referred to herein are incorporated by reference in their entirety to the same extent as if each individual publication, patent or patent application was specifically and individually indicated to be incorporated by reference in its entirety.

1. A method of manufacturing nano-crystalline cellulose film comprising the steps of (i) providing a suspension comprising nano-crystalline cellulose; (ii) uniformly dispensing the suspension onto at least one non-permeable sheet to form a film layer comprising nano-crystalline cellulose; (iii) drying the film layer using at least one non-contact drying apparatus; (iv) placing a semi-permeable sheet on the opposing surface of the film layer to the non-permeable sheet providing a sandwiched film configuration; (v) further drying the film layer using at least one drying apparatus; (vi) removing the non-permeable sheet and the semi-permeable sheet from the film layer; (vii) optionally further drying the film layer.

2. The method according to claim 1, wherein the suspension comprises less than about 10% solids.

3. The method according to claim 1, wherein the suspension comprises less than about 7% solids.

4. The method according to claim 1, wherein the suspension comprises about 5% solids.

5. The method according to claim 1, wherein the suspension consists essentially of nano-crystalline cellulose.

6. The method according to claim 1, wherein the suspension further comprises at least one additional material operable to form a film.

7. The method according to claim 6, wherein the at least one additional material is wood pulp.

8. The method according to claim 1, wherein the suspension further comprises at least one additive.

9. The method according to claim 8, wherein the at least one additive is a filler and/or a pigment.

10. The method according to claim 1, wherein the suspension further comprises at least one plasticizing agent.

11. The method according to claim 1, wherein the non-permeable sheet is formed from a material that does not allow the passage of fluids therethrough.

12. The method according to claim 1, wherein the at least one non-contact heating apparatus is selected from the group consisting of IR dryers, microwave dryers, steam dryers, and air impingement dryers.

13. The method according to claim 1, wherein step (iii) includes the use of more than one non-contact drying apparatus.

14. The method according to claim 1, wherein the semi-permeable sheet is operable to allow for the passage of fluids and/or gases therethrough.

15. The method according to claim 1, wherein the drying step (v) uses a cylindrical dryer onto which the sandwiched film is placed with the non-permeable sheet lying adjacent the surface of the dryer.

16. The method according to claim 15, wherein the drying step (v) uses more than one cylindrical dryer between which the sandwiched film passes.

17. The method according to claim 1, wherein step (vii) comprises the use of a series of drying units between which the gelled nano-crystalline film is passed.

18. The method according to claim 1, further comprising the step of (viii) passing the film layer through a gauging station to measure the properties of the film.

19. The method according to claim 1, further comprising the steps of calendering the film layer and/or coating the film layer

20. A nano-crystalline cellulose film manufactured by the method according to any one of claims 1 through 20.
